(19) United States
(12) Patent Application Publication
(10) Pub. No.: US 2022/0315332 A1
(43) Pub. Date: Oct. 6, 2022

(54) ROBOTIC APPARATUS WITH LATCH LOCK MECHANISM FOR TRANSPORTING INVENTORY

(71) Applicant: Grey Orange Inc., Roswell, GA (US)

(72) Inventors: Shalav GOEL, Haryana (IN); Varun SAINI, Punjab (IN)

(73) Assignee: Grey Orange Inc., Roswell, GA (US)

(21) Appl. No.: 17/710,093

(22) Filed: Mar. 31, 2022

(30) Foreign Application Priority Data
Mar. 31, 2021 (IN) 202111015325

(51) Int. Cl. B65G 1/04; B66F 9/18; B66F 9/06; B66F 9/075

(52) U.S. Cl. CPC B65G 1/0471; B65G 1/0492; B66F 9/18; B66F 9/063; B66F 9/0755; G05D 1/021

(57) ABSTRACT

A system for transporting inventory in a storage facility is disclosed. The system includes a control server, a robotic apparatus, and a payload (i.e., a mobile storage unit (MSU)). The robotic apparatus includes a track plate, a top plate superimposing the track plate, and a latch lock mechanism including a plurality of latch locks. The control server communicates instructions to the robotic apparatus for transporting the MSU. Based on the instructions, the robotic apparatus aligns beneath a base plate that is attached to a bottom surface of the MSU and raises the top plate to lift the MSU. When the top plate moves relative to the track plate, the plurality of latch locks engage with the base plate of the MSU based on a degree of alignment between the top plate and the base plate, to secure the MSU with the robotic apparatus.

### CROSS-REFERENCE TO RELATED APPLICATIONS/INCORPORATION BY REFERENCE

This patent application makes reference to, claims priority to, and claims the benefit of US provisional application IN202111015325 filed Mar. 31, 2021, the contents of which are hereby incorporated herein by reference in its entirety.

### FIELD

Various embodiments of the disclosure relate generally to inventory management systems. More specifically, various embodiments of the disclosure relate to methods and systems for transporting payload in a storage facility.

### BACKGROUND

Modern storage facilities or warehouses handle a large number of inventory items or packages of inventory items on a daily basis. Typically, the inventory items or the packages are stored in multiple storage units. The storage units are transported from one location to another location inside the storage facilities by way of robotic apparatus (for example, automated guided vehicles (AGVs)).

For transporting a storage unit between two locations, a robotic apparatus is required to accelerate and deaccelerate multiple times. Such acceleration and deceleration of the robotic apparatus causes the robotic apparatus to drift, and also generates an inertial load on the storage unit. The generation of the inertial load may cause variations in the center of gravity of the storage unit. Due to the varying center of gravity, there exists a risk of the storage unit leaving its contact with the robotic apparatus. This phenomenon is very critical as it affects the stability of the storage unit during transportation and may result in the toppling of the storage unit. The toppling of the storage unit may not only cause damage to the stored inventory items or packages but may also cause damage to nearby robotic apparatus and storage units. Further, a throughput and/or efficiency of operations at the storage facility may be adversely affected as a result of the toppling of the storage unit. Conventional techniques for securing a storage unit to a robotic apparatus utilize electromagnetic locks and sensors. The use of electromagnetic locks and sensors increases the overall cost of the storage units and the robotic apparatus used in the storage facility, which is not desirable.

In light of the foregoing, there exists a need for a technical and reliable solution that overcomes the abovementioned problems, and not only prevents the toppling of storage units during transportation but also improves throughputs for operations at a storage facility.

### SUMMARY

In an embodiment of the present disclosure, a system is disclosed. The system comprises a robotic apparatus. The robotic apparatus comprises a track plate, a top plate, a latch lock mechanism, a lifting mechanism, and a control device. The top plate is placed above the track plate, and spaced apart from the track plate. The top plate is configured to move in a vertical direction between a resting position and one of a plurality of raised positions with respect to the track plate. The latch lock mechanism is positioned between the top plate and the track plate. The lifting mechanism is coupled with the top plate, and configured to control a movement of the top plate with respect to the track plate. Based on the control of the movement of the top plate, the latch lock mechanism is actuated. The control device is configured to verify an alignment of the top plate with a base plate of a payload based on the robotic apparatus being stationed beneath the payload, and control the lifting mechanism to lift the top plate from the resting position to a first raised position at a first height at which the top plate comes in contact with the base plate. Based on the lifting of the top plate, the latch lock mechanism is actuated and securely engages with the base plate. The control device is further configured to control the lifting mechanism to lift the top plate from the first raised position to a second raised position at a second height based on the engagement of the latch lock mechanism with the base plate thereby lifting the payload off a work floor of a storage area.

In some embodiments, the control device is further configured to navigate the robotic apparatus from a first location to a second location for transporting the lifted payload, and control the lifting mechanism to lower the top plate from the second raised position to the first raised position based on the transportation of the payload to the second location. Based on the lowering of the top plate to the first raised position, the payload contacts the work floor of the storage area.

In some embodiments, the control device is further configured to instruct the lifting mechanism to lower the top plate from the first raised position to the resting position to disengage the latch lock mechanism from the base plate.

In some embodiments, the latch lock mechanism comprises a plurality of latch locks that actuate based on the movement of the top plate from the resting position to the first raised position, thereby causing the actuation of the latch lock mechanism.

In some embodiments, the control device is further configured to verify the alignment of the top plate with the base plate based on a count of latch locks of the plurality of latch locks whose movement is unobstructed by the base plate being greater than or equal to a permissible limit.

In some embodiments, a first latch lock of the plurality of latch locks comprises a connector, a lever pivoted to the connector at a pivoted joint, and a tension spring attached to the connector and the lever. The connector is attached to a bottom of the top plate.

In some embodiments, the top plate comprises a plurality of guide slots such that a tip end of the lever remains inserted in a first guide slot of the plurality of guide slots and a bottom end of the lever remains in contact with the track plate based on the top plate being at the resting position.

In some embodiments, based on the movement of the top plate from the resting position to the first raised position, tension in the tension spring is released, thereby causing the lever to rotate around the pivoted joint such that the tip end of the lever protrudes outwards of the guide slot and away from the track plate to engage with the base plate.

In some embodiments, the first latch lock further comprises a stop pin coupled to the connector, and positioned such that the stop pin contacts the bottom end of the lever based on the rotation of the lever around the pivoted joint.

In some embodiments, the control device is further configured to determine a successful engagement of the latch lock mechanism with the base plate based on a count of latch locks of the plurality of latch locks that are engaged with the base plate being greater than or equal to a permissible limit.

In some embodiments, a first latch lock of the plurality of latch locks comprises a lever, a first connector, and a tension spring. The lever is pivotally coupled to the first connector at a first pivoted joint, the second connector is pivotally coupled to the first connector at a second pivoted joint and affixed to a bottom of the top plate, and the tension spring is coupled to the lever and the first connector.

In some embodiments, the first latch lock further comprises a first support spring and a second support spring. The first connector is coupled to the first support spring and the second support spring. The first support spring and the second support spring are positioned on either side of the lever, and the first support spring and the second support spring remain in contact with the top plate.

In some embodiments, the first latch lock further comprises a blocking pin that protrudes from a surface of the first connector and contacts the top plate based on a downward movement of the first connector.

In some embodiments, the robotic apparatus further comprises a housing. The track plate is affixed to the top of the housing.

In some embodiments, the system further comprises a control server configured to communicate a transit instruction to the robotic apparatus. The transit instruction includes reference marker details of the payload and path details of a path that is to be traversed by the robotic apparatus for transporting the payload from a first location to a second location.

In some embodiments, the control server is further configured to select the robotic apparatus for lifting the payload based on a conformity between dimensions of the base plate of the payload and the top plate of the robotic apparatus.

In some embodiments, the robotic apparatus further comprises a plurality of wheels. The control device may be configured to determine a position of a Center of Gravity (COG) of the payload based on weight exerted by the payload on the plurality of wheels of the robotic apparatus.

In some embodiments, the control device is further configured to verify the alignment of the top plate with the base plate based on an alignment of a center of the base plate with a center of the top plate.

Methods and systems for transporting inventory in a storage facility are provided substantially as shown in, and described in connection with, at least one of the figures. The system includes a control server, at least one robotic apparatus communicatively coupled to the control server, and one or more mobile storage units (MSUs). The MSUs are used for storing various inventory items and/or various packages. Each MSU may include multiple shelves, which enable the MSUs to store multiple inventory items or packages. The bottom shelf (i.e., the lowermost shelf) of each MSU is referred to as “a base shelf”. Each MSU further includes a base plate mounted below the base shelf. The robotic apparatus is a robotic vehicle (i.e., automated guided vehicle, AGV) used in the storage facility for lifting and transporting the MSUs from one location to another location. The robotic apparatus may include a housing, a track plate, a top plate, and a latch lock mechanism. The track plate of the robotic apparatus is affixed to a top of the housing. The top plate super-imposes the track plate from a variable distance and moves relative to the track plate. In other words, the track plate and the top plate are spaced apart from each other. The robotic apparatus further includes a lifting mechanism that vertically moves the top plate over the track plate. The latch lock mechanism includes a plurality of latch locks. Each latch lock includes a connector, a lever pivoted to the connector, and a tension spring attached to the connector and the lever. Each connector is attached to a bottom of the top plate. Further, the top plate has a plurality of guide slots for receiving corresponding levers of the plurality of latch locks. A tip end of each lever remains inserted in a corresponding guide slot. Moreover, a bottom end of each lever remains in contact with the track plate when the track plate and the top plate are spaced apart by a first distance. Due to the relative movement between the track plate and the top plate, a distance between the track plate and the top plate increases. As a result, a tension on the tension springs attached to the connectors and the levers of the plurality of latch locks is released, thereby the levers rotate around corresponding pivoted joints causing the corresponding tip ends to protrude outwards from the corresponding guide slots. Hence, the plurality of latch locks function based on a relative movement between the track plate and the top plate.

The control server may be configured to receive a service request for fulfillment of an order. In one example, the service request may require one of the MSUs to be transported from a first location to a second location in the storage facility. The control server may be further configured to communicate one or more instructions to the robotic apparatus for transporting the MSU for the fulfillment of the order. The instructions may include one or more actions (for example, reaching the first position of the MSU, lifting the MSU, transporting the MSU to the second location, or the like) to be performed by the robotic apparatus for the fulfillment of the order. Based on the instructions, the robotic apparatus may reach the first location and align beneath the base plate of the MSU.

Upon aligning beneath the MSU, based on the instructions from the control server, the robotic apparatus may raise the corresponding top plate from a resting position (i.e., moves upwards in a vertical direction) to a first raised position at a first height where the top plate comes in contact with the base plate of the MSU. When the top plate is raised, one or more latch locks of the plurality of latch locks engage with the base plate to securely hold the MSU. The latch locks that get engaged with the base plate depend upon a degree of alignment between the top plate and the base plate, and one or more dimensions of the base plate.

Once the MSU is securely held by way of the engagement between the one or more latch locks and the base plate, the top plate is raised from the first height to a second raised position at a second height to lift the MSU off a work floor of the storage facility. The second raised position is at a greater height than the first raised position. The robotic apparatus transports the lifted MSU to the second location. Upon reaching the second location, based on the instructions from the control server, the robotic apparatus lowers the top plate (i.e., moves downward) from the second height to the first height such that the MSU contacts the work floor of the storage facility. The robotic apparatus further lowers the top plate from the first height to attain the resting position that leads to the top plate and the base plate being spaced at a minimal distance (i.e., the first distance) between each other. Based on the downward movement of the top plate, one or more latch locks disengage from the base plate. The one or more latch locks, upon disengaging, attains their original position between the top plate and the track plate. Therefore, the MSU is prevented from any unwanted movement or toppling while being transported by the robotic apparatus.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary environment of a storage facility, in accordance with an exemplary embodiment of the disclosure;

FIG. 2A is a schematic diagram that illustrates a front view of a robotic apparatus of FIG. 1, in accordance with an exemplary embodiment of the disclosure;

FIG. 2B is a schematic diagram that illustrates an exploded view of a top portion of the robotic apparatus of FIG. 1, in accordance with an exemplary embodiment of the disclosure;

FIGS. 3A and 3B are schematic diagrams that illustrate a side view and an exploded view of a latch lock of the robotic apparatus of FIG. 1, in accordance with an exemplary embodiment of the disclosure;

FIGS. 4A and 4B are schematic diagrams that collectively illustrate various operations performed by the robotic apparatus of FIG. 1 for transportation of mobile storage units, in accordance with an exemplary embodiment of the disclosure;

FIG. 5 is a schematic diagram that illustrates a side view of a latch lock of the robotic apparatus of FIG. 1, in accordance with another exemplary embodiment of the disclosure;

FIGS. 6A and 6B are schematic diagrams that collectively illustrate various operations of the latch lock of FIG. 5, in accordance with another exemplary embodiment of the disclosure;

FIG. 7 is a schematic diagram that illustrates an exemplary scenario of alignment between a base plate of a mobile storage unit and a top plate of the robotic apparatus of FIG. 1, in accordance with an exemplary embodiment of the disclosure; and

FIG. 8 is a block diagram that illustrates a system architecture of a computer system in a storage facility, in accordance with an exemplary embodiment of the disclosure.

### DETAILED DESCRIPTION

Certain embodiments of the disclosure may be found in disclosed systems and methods for transporting inventory in a storage facility. Exemplary aspects of the disclosure provide methods for transporting inventory in a storage facility.

The methods and systems of the disclosure provide a solution for transporting inventory in a storage facility using a set of robotic apparatus, e.g., automated guided vehicles, AGVs. The method and system disclosed herein eliminate the risk of damage caused to the inventory or mobile storage units (MSUs) due to toppling and falling.

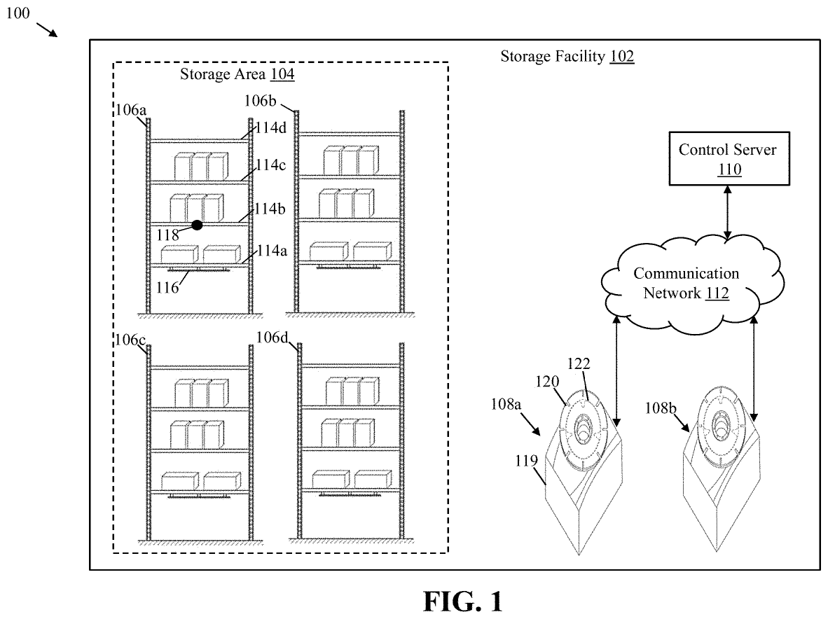

FIG. 1 is a block diagram that illustrates an exemplary environment 100 of a storage facility 102, in accordance with an exemplary embodiment of the disclosure. The storage facility 102 includes a storage area 104, a plurality of payloads (referred to as mobile storage units (MSUs)) 106a-106d, a plurality of set of robotic apparatus 108a and 108b (hereinafter, collectively referred to and designated as “the set of robotic apparatus 108”), and a control server 110. The plurality of MSUs 106a-106d are hereinafter collectively referred to and designated as “the MSUs 106”. The control server 110 is configured to communicate with the set of robotic apparatus 108 by way of a communication network 112 or via separate communication networks established therebetween. The communication network 112 is a medium through which instructions and messages are transmitted between the set of robotic apparatus 108 and the control server 110. Examples of the communication network 112 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, and a combination thereof. Various entities (such as the set of robotic apparatus 108 and the control server 110) in the environment 100 may be coupled to the communication network 112 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The storage facility 102 is a facility where inventory items or packages of inventory items are stored for order fulfillment and/or selling. Examples of the storage facility 102 may include, but are not limited to, a forward warehouse, a backward warehouse, a fulfilment center, or a retail store (e.g., a supermarket, an apparel store, a departmental store, a grocery store, or the like). Examples of the inventory items may include, but are not limited to, groceries, apparel, electronic goods, mechanical goods, or the like. The storage facility 102 has the storage area 104 where the MSUs 106 are placed for storing the inventory items or the packages. The storage area 104 may be of any shape, for example, a rectangular shape. In one embodiment, the MSUs 106 in the storage area 104 may be arranged to form aisles therebetween. Arrangement of the MSUs 106 in the storage area 104 is a standard practice and will be apparent to those of skill in the art.

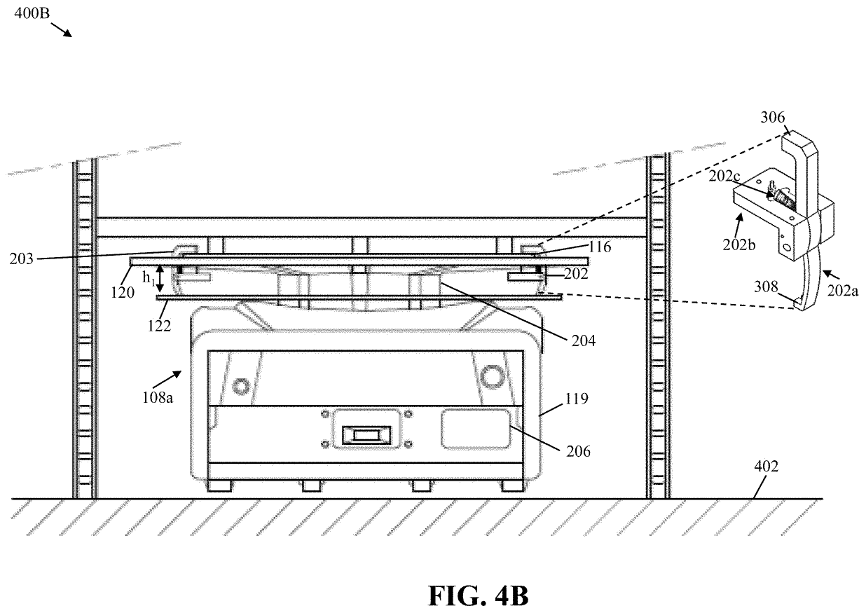

The MSUs 106 are units for storing various inventory items and/or various packages. The MSUs 106 are transported by the set of robotic apparatus 108 within the storage facility 102, for order fulfillment or replenishment of the inventory. Each MSU 106 may include multiple shelves, which enable the MSUs 106 to store multiple inventory items or packages. The bottom shelf (e.g., the lowermost shelf) of each MSU 106 is referred to as “a base shelf”. Each MSU 106 further includes a base plate mounted below the corresponding base shelf such that a center of the base shelf is in alignment (for example, coincide) with a center of the corresponding base plate. In one embodiment, the base plate, in each MSU 106, maybe affixed below the base shelf. In another embodiment, the base plate, in each MSU 106, may be detachably attached to the base shelf. For example, as shown in FIG. 1, the MSU 106a includes first through fourth shelves 114a-114d and a base plate 116 mounted below the first shelf 114a (i.e., the base shelf 114a of the MSU 106a). Structural details of the base plate 116 are described later in conjunction with FIG. 4A. In one embodiment, the base plate 116 may have a circular shape. However, in other embodiments, the base plate 116 may have any other shape (for example, triangular, rectangular, pentagonal, or the like) without limiting the scope of the disclosure.

Each MSU 106 may further include a reference marker attached to or formed on a bottom surface (i.e., a surface that faces a work floor) of the corresponding base plate for uniquely identifying the corresponding MSU 106. Examples of the reference marker may include, but are not limited to, a barcode, a quick response (QR) code, a radio frequency identification device (RFID) tag, or the like. It will be apparent to those of skill in the art that the MSUs 106 may further include additional structural features that aid in carrying or otherwise transporting the MSUs 106, without deviating from the scope of the disclosure.

Each MSU 106 has a corresponding center of gravity (COG). A position of the COG of each MSU 106 may vary based on various factors, such as dimensions, configuration, shape, and weight of the corresponding MSU 106, and dimensions of the shelves of the corresponding MSU 106. The position of the COG of each MSU 106 may further vary based on a weight, a shape, dimensions, and a storage position of each inventory item stored in the corresponding MSU 106. For example, as shown in FIG. 1, the MSU 106a has the COG at a position 118. The position 118 of the COG of the MSU 106a may be based on the dimensions, the shape, the configuration, the weight of the MSU 106a, and the dimensions of the shelves 114a-114d of the MSU 106a. Position 118 of the COG of the MSU 106a may be further based on the weight, shape, and dimensions of the inventory items stored in the MSU 106a.

The set of robotic apparatus 108 includes robotic vehicles (i.e., automated guided vehicles, AGVs) used in the storage facility 102 for lifting and transporting the MSUs 106 from one location to another location. The set of robotic apparatus 108 may be configured to communicate with the control server 110. The set of robotic apparatus 108 may vary in terms of sizes, dimensions, weight lifting capacity, or the like. Each robotic apparatus 108 includes a housing, a track plate, a top plate, and a latch lock mechanism. For example, as shown in FIG. 1, the robotic apparatus 108a includes a housing 119, a top plate 120, and a track plate 122 mounted beneath the top plate 120. The top plate 120 and the track plate 122 are centrally aligned and spaced apart from each other. Each robotic apparatus 108 further includes a control device and a lifting mechanism that is coupled with the top plate 120 and configured to control a movement of the top plate 120 with respect to the track plate 122 (i.e., vertically moves the top plate 120 with respect to the track plate 122). The control device may include suitable logic, circuitry, interfaces, and/or code, executable by the circuitry, to execute various operations to control functioning of the set of robotic apparatus 108. For example, the control device of the robotic apparatus 108a may be configured to control the lifting mechanism to vertically move the top plate 120 with respect to the track plate 122.

The set of robotic apparatus 108 that is in an available state may be configured to receive requests from the control server 110 for transportation of the MSUs 106. The available state of a robotic apparatus of the set of robotic apparatus 108 refers to a state of the robotic apparatus during which the robotic apparatus is available for transporting the MSUs 106. During the available state of the robotic apparatus, corresponding top plates remain in a resting position.

The control server 110 may include suitable logic, circuitry, interfaces, and/or code, executable by the circuitry, to facilitate various inventory management operations in the storage facility 102. Examples of the control server 110 may include, but are not limited to, personal computers, laptops, mini-computers, mainframe computers, any non-transient and tangible machine that can execute a machine-readable code, cloud-based servers, distributed server networks, or a network of computer systems. The control server 110 may be realized through various web-based technologies such as, but not limited to, a Java web framework, a .NET framework, a personal home page (PHP) framework, or any other web application framework. The control server 110 may be maintained by a storage facility management authority or a third-party entity that facilitates inventory management and handling operations for the storage facility 102. It will be understood by a person having ordinary skill in the art that the control server 110 may execute other storage facility management operations as well along with the inventory management operations.

The control server 110 may be configured to communicate transit instructions to the set of robotic apparatus 108 for transporting the MSUs 106. Each transit instruction may include reference marker details of at least one MSU 106 that needs to be transported and path details of a path that is to be traversed by each robotic apparatus 108 for transporting the corresponding MSUs 106. The control server 110 may be further configured to determine the position of the COG and a COG tolerance region for each MSU 106. For example, the COG tolerance region of the MSU 106a may define a permissible COG range for the MSU 106a such that if the COG of the MSU 106a is maintained within the COG tolerance region, the MSU 106a is stable and may not topple during transportation.

The control server 110 may be further configured to store, in a memory of the control server 110, a virtual map of the storage facility 102, and inventory storage data of the inventory stock. The virtual map is indicative of the current location of the MSUs 106, entry and exit points of the storage facility 102, various reference markers in the storage facility 102, a current location of each robotic apparatus 108, or the like. The inventory storage data is indicative of associations between the inventory items stored in the storage facility 102 and the MSUs 106 in the storage facility 102. The inventory storage data may further include historic storage locations of each inventory item. The inventory storage data further includes parameters (for example, weight, shape, size, color, dimensions, or the like) associated with each inventory item.

For the sake of brevity, the ongoing description is described with respect to the MSU 106a and the robotic apparatus 108a. In other embodiments, a movement of other MSUs could be facilitated using the robotic apparatus 108a or any other robotic apparatus in a similar manner.

In operation, the control server 110 may receive a service request that requires the MSU 106a (e.g., a payload) to be transported from a first location to a second location in the storage facility 102. In one embodiment, the first location corresponds to a pickup location or an initial location of the MSU 106a, and the second location corresponds to a drop location or a destination location of the MSU 106a. The control server 110 may then communicate a transit instruction, including navigation details, to the robotic apparatus 108a via the communication network 112 for instructing the robotic apparatus 108a to transport the MSU 106a from the first location to the second location. Based on the transit instruction, the robotic apparatus 108a reaches the first location and aligns beneath the base plate 116 of the MSU 106a. The control device of the robotic apparatus 108a verifies the alignment of the top plate 120 of the robotic apparatus 108a with the base plate 116. In an example, the control device of the robotic apparatus 108a verifies whether a center of the top plate 120 of the robotic apparatus 108a coincides with a center of the base plate 116. When the robotic apparatus 108a is stationed beneath the MSU 106a, based on an alignment between the top plate 120 and the base plate 116, the robotic apparatus 108a receives a first lifting instruction from the control server 110 to lift the top plate 120 from the resting position to a first height. Based on the first lifting instruction, the control device of the robotic apparatus 108a controls the corresponding lifting mechanism to raise the top plate 120 with respect to the track plate 122 until the first height is reached. The lifting mechanism transmits information pertaining to a current height of the top plate 120 to the control device. The control device is further configured to process the received information to determine successful lifting of the top plate to the first height. Based on an upward movement of the top plate 120 (i.e., a successful lifting of the top plate 120), the latch lock mechanism of the robotic apparatus 108a is actuated. When the top plate 120 is raised to the first height, the top plate 120 comes in contact with the base plate 116 and the latch lock mechanism of the robotic apparatus 108a engages with the base plate 116 to securely hold the MSU 106a. Upon engagement of the latch lock mechanism with the base plate 116, the robotic apparatus 108a receives a second lifting instruction from the control server 110 to lift the top plate 120 from the first height to a second height. Based on the second lifting instruction, the control device of the robotic apparatus 108a controls the corresponding lifting mechanism to raise (or lift) the top plate 120 from the first height to the second height, thereby lifting the MSU 106a off a work floor of the storage area 104. Subsequently, the robotic apparatus 108a transports the lifted MSU 106a from the first location to the second location.

Upon detecting that the robotic apparatus 108a has reached the second location with the MSU 106a, the control server 110 instructs the robotic apparatus 108a to lower the top plate 120 from the second height to the resting position. Based on the instruction, the control device of the robotic apparatus 108a controls the corresponding lifting mechanism to lower (i.e., moves downward) the top plate 120 from the second height to the first height. When the top plate 120 reaches the first height, the MSU 106a contacts the work floor of the storage area 104. Subsequently, the top plate 120 is further lowered from the first height to the resting position. Such downward movement of the top plate 120 causes the latch lock mechanism to disengage from the base plate 116 of the MSU 106a, thereby releasing the secure hold on the MSU 106a.

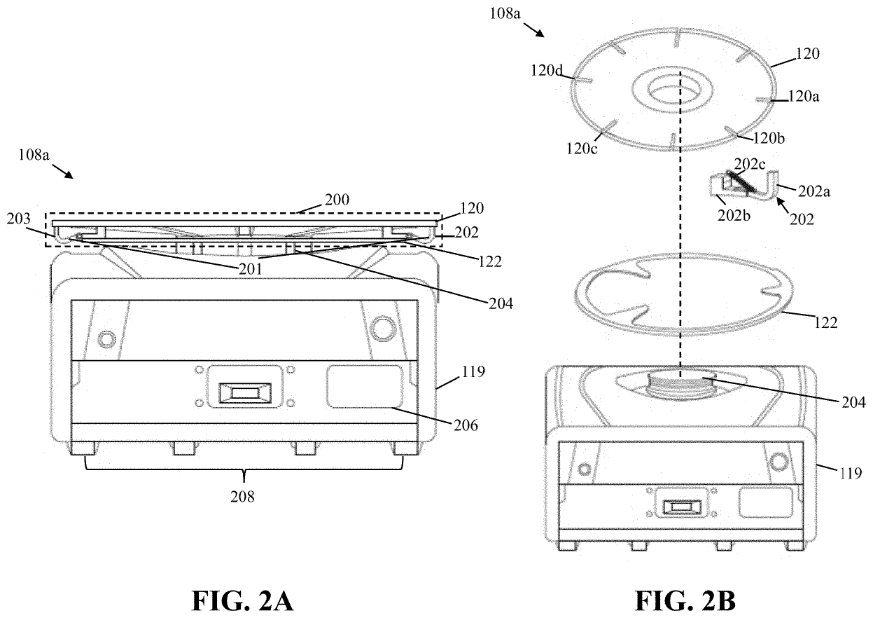

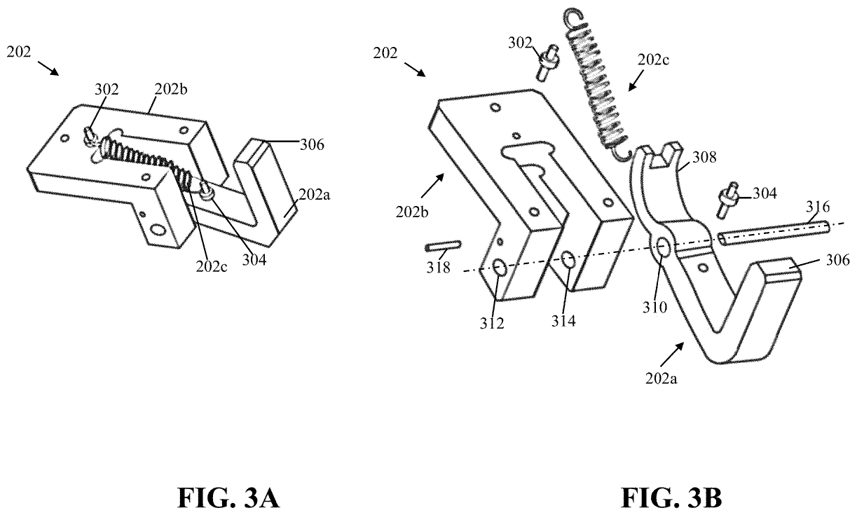

FIG. 2A is a schematic diagram that illustrates a front view of the robotic apparatus 108a, in accordance with an exemplary embodiment of the disclosure. As shown in FIG. 2A, the robotic apparatus 108a includes the housing 119, the top plate 120, and the track plate 122. The robotic apparatus 108a further includes the latch lock mechanism 201 including a plurality of latch locks, for example, a first latch lock 202 and a second latch lock 203 positioned between the top plate 120 and the track plate 122. The top plate 120, the track plate 122, and the latch lock mechanism 201 are collectively referred to as “a top portion 200” of the robotic apparatus 108a. The robotic apparatus 108a further includes the lifting mechanism (hereinafter, referred to as “the lifting mechanism 204”), the control device (hereinafter, referred to and designated as the “control device 206”), a plurality of wheels 208, sensors (not shown), a motor driver (not shown), motors (not shown), and a network interface (not shown). The lifting mechanism 204, the control device 206, the sensors, the motor, the motor driver, and the network interface may be housed within the housing 119.

The network interface may include suitable logic, circuitry, interfaces, and/or code, executable by the circuitry, for facilitating communication using one or more communication protocols. For example, the network interface may facilitate communication between the robotic apparatus 108a and the control server 110. Examples of the network interface may include, but are not limited to, an antenna, a radio frequency transceiver, a wireless transceiver, a Bluetooth transceiver, an ethernet-based transceiver, a universal serial bus (USB) transceiver, or any other device configured to transmit and receive data.

The control device 206 may be configured to navigate the robotic apparatus 108a in the storage facility 102. The control device 206 may be further configured to determine a position of the COG of the MSU 106a based on a weight distribution profile of the MSU 106a. The control device 206 may be further configured to control the movement of the top plate 120 by way of the lifting mechanism 204. The control device 206 may include an absolute encoder, a position determiner, a direction controller, and an engagement indicator (not shown).

The lifting mechanism 204 may be configured to controllably move the top plate 120 under the control of the control device 206. The lifting mechanism 204 may comprise a linear actuator. The linear actuator may be configured to controllably raise or lower the top plate 120 with respect to the track plate 122 to attain different orientations for the top plate 120. For example, the linear actuator may vertically move the top plate 120 from the resting position (i.e., a home or default position) to multiple raised positions such as a first raised position at the first height and a second raised position at the second height. The linear actuator may further lower the top plate 120 from multiple raised positions to the resting position. The lifting mechanism 204 may determine a height of lift required for a raised position of the top plate 120 based on one or more control signals received from the absolute encoder. In another embodiment, the lifting mechanism 204 may raise or lower the top plate based on image sensors (not shown).

The motor driver may include suitable logic, circuitry, interfaces, and/or code, executable by the circuitry, for driving the motors coupled to the plurality of wheels 208. For example, the motor driver may provide current to the motors to drive the plurality of wheels 208. In one embodiment, the motor driver may vary the current provided to the motors to vary the speed of the rotation of the plurality of wheels 208.

The sensors may include, but are not limited to, one or more photosensors, one or more image sensors, one or more proximity sensors, or one or more weight sensors. For example, the photosensors may be configured to scan the reference markers on the MSUs 106 and provide an input to the control device 206 for identifying a required MSU from the MSUs 106. The weight sensors may be configured to determine the weight exerted by the lifted MSU 106a on each of the plurality of wheels 208 of the robotic apparatus 108a. The weight sensors may be further configured to provide an input, indicating the weight exerted by the lifted MSU 106a on each of the plurality of wheels 208, to the control device 206. For example, the control device 206 may be configured to determine the position of the COG of the MSU 106a based on the weight exerted by the MSU 106a on each of the plurality of wheels 208. It will be apparent to those of skill in the art that other sensors, may be used for determining various parameters mentioned above, without deviating from the scope of the disclosure.

The absolute encoder may include suitable logic, circuitry, interfaces, and/or code, executable by the circuitry, for transforming a lateral position into a control signal to be processed by the lifting mechanism 204. Thus, the absolute encoder may provide different control signals for different linear positions of the top plate 120. For example, if the top plate 120 is to be raised to the first height from the resting position, the control device 206 may transmit a control signal to the lifting mechanism 204, based on which the lifting mechanism 204 may raise the top plate 120 to the first height from the resting position.

The position determiner and the direction controller may enable the robotic apparatus 108a to navigate through the storage facility 102. For example, the position determiner may be configured to determine a real-time position of the robotic apparatus 108a in the storage facility 102. The direction controller may be configured to control the direction of movement of the robotic apparatus 108a in the storage facility 102 with respect to the current location.

The engagement indicator may indicate a state of each of the plurality of latch locks (e.g., the first and second latch locks 202 and 203). For example, when the engagement indicator is set to a default value “0” for the first latch lock 202, the first latch lock 202 is in a default position and not actuated. When the engagement indicator is set to a first value “1” for the first latch lock 202, the first latch lock 202 is actuated or in a state of engagement. The top portion 200 of the robotic apparatus 108a is described in conjunction with FIG. 2B.

Referring now to FIG. 2B, a schematic diagram that illustrates an exploded view of the top portion 200 of the robotic apparatus 108a is shown, in accordance with an exemplary embodiment of the disclosure.

The track plate 122 is affixed to the top of the housing 119. The top plate 120 super-imposes the track plate 122 from a variable distance (i.e., a first distance) and moves relative to the track plate 122 under the control of the lifting mechanism 204. In other words, the track plate 122 and the top plate 120 are spaced apart from each other by the first distance. The top plate 120 is considered to be at the resting position when the top plate 120 is spaced apart from the track plate 122 by the first distance.

Each of the plurality of latch locks includes a connector, a lever pivoted to the connector at a pivoted joint, and a tension spring attached to the connector and the lever. The plurality of latch locks include the first latch lock 202 and the second latch lock 203. For example, the first latch lock 202 includes a lever 202a pivoted to a first connector 202b at a first pivoted joint and a tension spring 202c attached to the first connector 202b and the lever 202a. The first connector 202b of the first latch lock 202 is attached to a bottom of the top plate 120 by way of screws or adhesives.

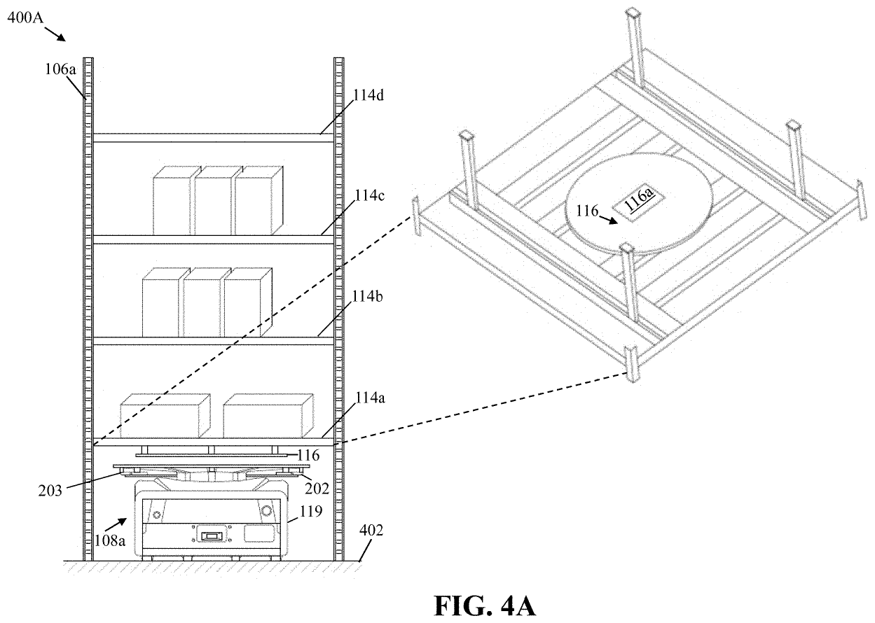

The top plate 120 includes a plurality of guide slots 120a-120n (for the sake of brevity, only four guide slots are labeled in FIG. 2B) for receiving the levers of the plurality of latch locks. A tip end of each lever remains inserted in a corresponding guide slot 120a-120n when the top plate 120 is at the resting position. Moreover, a bottom end (i.e., a tail end) of each lever remains in contact with the track plate 122 when the track plate 122 and the top plate 120 are spaced apart by the first distance. When the top plate 120 and the track plate 122 are spaced by the first distance, the tip end of each lever is moved away from the corresponding connector, thereby causing tension in the tension springs. The tension springs of the plurality of latch locks are elongated due to tension. In other words, the first distance is a threshold distance that is required to be maintained between the top plate 120 and the track plate 122 so as to create required tension in the tension springs, thereby keeping the levers of the plurality of latch locks inserted inside the corresponding guide slots 120a-120n. For example, the guide slot 120a receives the lever 202a of the first latch lock 202 such that a tip end (as shown in FIG. 3A) of the lever 202a remains inserted in the guide slot 120a when the top plate 120 is at the resting position, i.e., when the track plate 122 and the top plate 120 are spaced apart by the first distance. Further, a bottom end of the lever 202a remains in contact with the track plate 122 when the track plate 122 and the top plate 120 are spaced apart by the first distance and the tension spring 202c is elongated due to tension.

Due to the relative movement between the track plate 122 and the top plate 120, a distance between the track plate 122 and the top plate 120 increases. As a result, a tension on the tension springs of the plurality of latch locks is released, thereby the levers rotate around corresponding pivoted joints causing the corresponding tip ends to protrude outwards (i.e., in a direction away from the track plate 122) from the corresponding guide slots 120a-120n. For example, when a distance between the track plate 122 and the top plate 120 becomes more than the first distance, a tension on the tension spring 202c is gradually released. As a result, the lever 202a rotates around the pivoted joint, causing the tip end of the lever 202a that was previously inserted in the guide slot 120a to protrude outwards (i.e., in a direction away from the track plate 122) from the guide slot 120a Similarly, due to a movement of the top plate 120, the remaining latch locks also get actuated. Hence, the plurality of latch locks are actuated based on a relative movement between the track plate 122 and the top plate 120.

Although the plurality of latch locks shown in FIGS. 2A and 2B function based on the tension created in the corresponding tension springs, the scope of the disclosure is not limited to it. In another embodiment, the plurality of latch locks are electronic latch locks whose actuation is controlled by a motor drive. In other words, based on the movement of the top plate 120, the motor drive may control the movement of the levers of the plurality of latch locks.

In another embodiment, the top portion 200 of the robotic apparatus 108a may further include a spacer (not shown) in between the top plate 120 and the track plate 122. The spacer may maintain a threshold distance (i.e., the first distance) between the top plate 120 and the track plate 122 so as to create required tension in the tension springs which keeps the levers of the plurality of latch locks inserted inside the corresponding guide slots 120a-120n.

FIGS. 3A and 3B are schematic diagrams that respectively illustrate a side view and an exploded view of the first latch lock 202, in accordance with an exemplary embodiment of the disclosure.

With reference to FIG. 3A, the first latch lock 202 is shown to be in its default position, i.e., a position of the first latch lock 202 when the top plate 120 and the track plate 122 are spaced apart by the first distance. As shown, the first latch lock 202 includes the lever 202a, the first connector 202b, and the tension spring 202c. The tension spring 202c is coupled to the first connector 202b and the lever 202a by way of a first set of screws 302 and a second set of 304. The tip end of the first latch lock 202 that remains inserted in the guide slot 120a is designated as “the tip end 306”. Since the first connector 202b is affixed to the bottom of the top plate 120, any movement in the lever 202a causes the tension spring 202c to elongate or compress.

With reference to FIG. 3B, the bottom end of the first latch lock 202 that remains in contact with the track plate 122 in the default position is designated as “the bottom end 308”. The lever 202a is pivotally coupled to the first connector 202b at a pivoted joint 310. The first connector 202b includes a first opening 312 and a second opening 314. The first latch lock 202 further includes a hinge pin 316 that passes through the first and second openings 312 and 314 for rotatably attaching the lever 202a to the first connector 202b at the pivoted joint 310. While the top plate 120 is raised from the resting position, the lever 202a rotates around the hinge pin 316. The first latch lock 202 further includes a stop pin 318. The stop pin 318 is coupled to the first connector 202b. The stop pin 318 is positioned in a way that it contacts the bottom end 308 of the lever 202a based on the rotation of the lever 202a around the pivoted joint 310 to block the lever 202a from unnecessary rotation.

FIGS. 4A and 4B are schematic diagrams 400A and 400B that collectively illustrate various operations performed by the robotic apparatus 108a for transporting the MSU 106a, in accordance with an exemplary embodiment of the disclosure.

Referring to FIG. 4A, the control server 110 may receive a service request that requires transportation of the MSU 106a (e.g., the payload) from the first location to the second location in the storage facility 102. Based on the received service request, the control server 110 selects a robotic apparatus from the set of robotic apparatus 108 that is available for catering to the service request. In one example, the control server 110 may select the robotic apparatus 108a for catering to the service request.

The control server 110 further determines a first optimal path in the storage facility 102 that is to be traversed by the robotic apparatus 108a for reaching the first location, where the MSU 106a is positioned, from its current location. The control server 110 further determines a second optimal path in the storage facility 102 that is to be traversed by the robotic apparatus 108a for reaching the second location from the first location, after lifting the MSU 106a. The control server 110 then communicates the transit instruction to the robotic apparatus 108a. The transit instruction may include path details of the first and second optimal paths, and details of the reference marker of the MSU 106a.

Based on the transit instruction, the robotic apparatus 108a reaches the first location from its current location, aligns beneath the MSU 106a, and scans a reference marker 116a marked at the bottom surface of the base plate 116 to identify the MSU 106a for transportation. In FIG. 4A, the robotic apparatus 108a is shown to be aligned beneath the MSU 106a and the top plate 120 is positioned directly below the base plate 116. The alignment of the base plate 116 and the top plate 120 should be in a way that a center of the base plate 116 aligns (e.g., coincides) with a center of the top plate 120. When the robotic apparatus 108a is aligned beneath the base plate 116, the top plate 120 is in the resting position, i.e., the top plate 120 and the track plate 122 of the robotic apparatus 108a are spaced apart by the first distance and the plurality of latch locks of the robotic apparatus 108a are in the default position due to the tension created in the corresponding tension springs. For example, the tip end 306 of the first latch lock 202 remains inserted in the guide slot 120a and the bottom end 308 of the first latch lock 202 remains in contact with the track plate 122 due to the tension in the tension spring 202c.

The robotic apparatus 108a may be configured to communicate an alignment notification to the control server 110 to indicate a degree of alignment between the top plate 120 and the base plate 116. Based on the alignment notification, the control server 110 may determine a count of latch locks of the robotic apparatus 108a whose movement is unobstructed by the base plate 116. The control server 110 further determines whether the determined count of latch locks is within a permissible limit that allows lifting of the MSU 106a. The permissible limit defines a minimum number of latch locks that are required to securely hold the MSU 106a to the robotic apparatus 108a. For example, if the permissible limit for the base plate 116 is four, a minimum of four latch locks of the robotic apparatus 108a are required to be engaged with the base plate 116 for securely holding the base plate 116. In an embodiment, when the determined count is less than the permissible limit, the control server 110 may instruct the robotic apparatus 108a to correct the alignment between the top plate 120 and the base plate 116. In an embodiment, when the determined count is the same as or greater than the permissible limit, the control server 110 may communicate the first lifting instruction to the robotic apparatus 108a. In other words, the alignment of the base plate 116 and the top plate 120 is successly verified based on (i) alignment between the centers of the base plate 116 and the top plate 120, and/or (ii) the determined count of latch locks whose movement is unobstructed by the base plate 116 being within the permissible limit.

Based on the first lifting instruction, the control device 206 controls the lifting mechanism 204 to lift the top plate 120 to the first height (h₁) (as shown in FIG. 4B) from the resting position. For example, when the control device 206 determines that the top plate 120 is to be lifted by 5 millimeters (mm) from the resting position, the absolute encoder may generate a first control signal corresponding to 5 mm, for instructing the lifting mechanism 204 to lift the top plate 120 by 5 mm.

Based on the control signal, the lifting mechanism 204 gradually lifts the top plate 120 from the resting position to the first height (h₁) at which the top plate 120 comes in contact with the base plate 116. While the top plate 120 transitions from the resting position to the first height (h₁), one or more of the plurality of latch locks of the robotic apparatus 108a are actuated. In a non-limiting example, it is assumed that the top plate 120 is centrally aligned with the base plate 116, thereby causing the plurality of latch locks to actuate when the top plate 120 is lifted (or raised).

For example, due to the upward movement of the top plate 120 with respect to the track plate 122, the tension in the tension springs of the plurality of latch locks is gradually released, causing the levers (e.g., the lever 202a) of the plurality of latch locks to rotate around the corresponding pivoted joints (e.g., around corresponding hinge pins). As a result, a tip end of the levers of the plurality of latch locks protrudes outwards of the corresponding guide slots to engage with the base plate 116. The bottom end of the levers of the plurality of latch locks comes in contact with corresponding stop pins, thereby blocking an additional movement of the levers. Upon engagement of the plurality of latch locks with the base plate 116, the MSU 106a is securely held.

Based on lifting of the top plate 120 to the first height (h₁), the lifting mechanism 204 transmits information pertaining to a current height of the top plate 120 to the control device 206. The absolute encoder processes the received information to determine successful lifting of the top plate 120 to the first height (h₁).

Referring now to FIG. 4B, the latch lock mechanism of the robotic apparatus 108a is shown to be engaged with the base plate 116. FIG. 4B further illustrates a protruded position of the plurality of latch locks of the robotic apparatus 108a.

The engagement indicator for the plurality of latch locks (e.g., the first and second latch locks 202 and 203) that get engaged with the base plate 116 is updated from “0” to “1” by the control device 206 indicating an actuated state of the plurality of latch locks. The robotic apparatus 108a then communicates an engagement notification to the control server 110. The engagement notification indicates the engagement indicators of the plurality of latch locks. The control server 110 upon determining that the permissible limit of the latch locks is satisfied, communicates the second lifting instruction to the robotic apparatus 108a. Based on the second lifting instruction, the control device 206 is configured to lift the top plate 120 to the second height from the first height. The absolute encoder then generates another control signal, corresponding to the second height, for instructing the lifting mechanism 204 to lift the top plate 120 to the second height. Based on lifting the top plate 120 to the second height, the lifting mechanism 204 transmits information pertaining to a current height of the top plate 120 to the control device 206. The absolute encoder processes the received information to determine successful lifting of the top plate 120 to the second height. When the control device 206 lifts the top plate 120 to the second height, the MSU 106a gets lifted off the work floor 402 of the storage facility 102 due to a secure engagement between the latch lock mechanism of the robotic apparatus 108a and the base plate 116, and contact between a bottom surface of the base plate 116 and a top surface of the top plate 120. In a non-limiting example, the top surface of the top plate 120 facing the base plate 116 may be rubber coated to avoid damage to the base plate 116 during transportation. The top plate 120 may have a coating of other similar materials, without deviating from the scope of the present disclosure.

Upon lifting the MSU 106a, the control device 206 is further configured to navigate the robotic apparatus 108a from the first location to the second location for transporting the MSU 106a. The engagement between the latch lock mechanism and the base plate 116 prevents the MSU 106a from toppling during transportation.

Upon reaching the second location in the storage facility 102, the control server 110 instructs the robotic apparatus 108a to place the lifted MSU 106a on the work floor 402 of the storage facility 102. Based on the instruction of the control server 110, the control device 206 instructs the lifting mechanism 204 to gradually lower the top plate 120 from the second height to the resting position to place the MSU 106a on the work floor 402. Due to gradual lowering of the top plate 120, the engaged plurality of latch locks gradually disengage from the base plate 116 and attain their default position. Upon placing the MSU 106a on the work floor 402, the robotic apparatus 108a may further communicate an acknowledgment to the control server 110 to indicate that the MSU 106a is successfully transported to the second location.

In another embodiment, various operations performed by the control server 110 to facilitate transportation of the MSU 106a may be locally performed at the robotic apparatus 108a by the control device 206. In such an embodiment, the control device 206 may be configured to verify the alignment between the base plate 116 and the top plate 120. To verify the alignment, the control device 206 may determine a count of latch locks whose movement is unobstructed by the base plate 116. The control device 206 may further determine whether the determined count of latch locks is within the permissible limit that allows lifting of the MSU 106a. When the determined count is less than the permissible limit, the control device 206 may control movement of the robotic apparatus 108a so as to correct the alignment between the top plate 120 and the base plate 116. However, when the determined count is the same as or greater than the permissible limit, the control device 206 may generate the first lifting instruction and control the lifting mechanism 204 to lift the top plate 120 to the first height (h₁) from the resting position. Based on lifting of the top plate 120 to the first height (h₁), the lifting mechanism 204 transmits information pertaining to a current height of the top plate 120 to the control device 206. The absolute encoder processes the received information to determine successful lifting of the top plate 120 to the first height (h₁). The control device 206 may determine whether the permissible limit of the latch locks is satisfied. When the permissible limit of the latch locks is satisfied, the control device 206 generates the second lifting instruction and causes the lifting mechanism 204 to lift the top plate 120 to the second height from the first height. Upon reaching the second location in the storage facility 102, the control device 206 may instruct the lifting mechanism 204 to gradually lower the top plate 120 from the second height to the resting position to place the MSU 106a on the work floor 402.

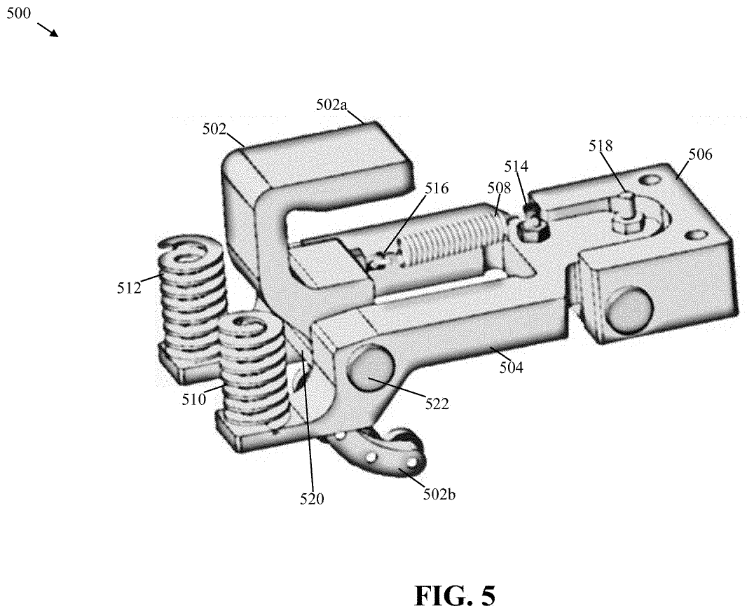

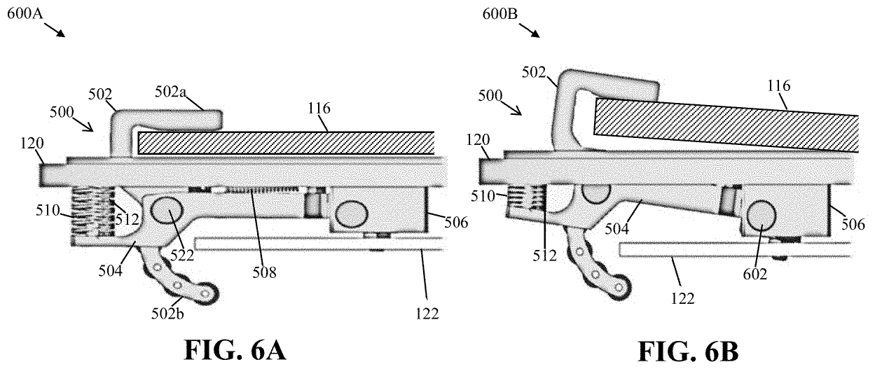

FIG. 5 is a schematic diagram that illustrates a side view of a latch lock of the robotic apparatus of FIG. 1, in accordance with another exemplary embodiment of the disclosure. Referring to FIG. 5, illustrated is a latch lock 500 in its engaged position, i.e., a position of the latch lock 500 when the top plate 120 of the robotic apparatus 108a is in contact with the base plate 116 of the MSU 106a. The engagement of the latch lock 500 with the top plate 120 and the base plate 116 is illustrated in FIGS. 6A and 6B. As shown, the latch lock 500 includes a lever 502, a second connector 504, a third connector 506, a tension spring 508, a first support spring 510, and a second support spring 512. The tension spring 508 is coupled to the lever 502 and the second connector 504 by way of a third set of screws 514 and a fourth set of screws 516. The lever 502 is pivotally coupled to the second connector 504 at a first pivoted joint 522. The second connector 504 is pivotally coupled to the third connector 506. The third connector 506 is affixed to the bottom of the top plate 120. The second connector 504 is coupled to the first and second support springs 510 and 512. The first and second support springs 510 and 512 are positioned on either side of the lever 502. The first and second support springs 510 and 512 remain in contact with the top plate 120. A tip end 502a of the latch lock 500 remains inserted in a corresponding guide slot of the top plate 120. Since the lever 502 is pivoted to the second connector 504, any movement in the lever 502 causes the tension spring 508 to elongate or compress. The latch lock 500 further includes a blocking pin 518 that restricts an undesirable movement of the second connector 504. The blocking pin 518 protrudes from a surface of the second connector 504. The blocking pin 518 comes in contact with the top plate 120 based on an anti-clockwise (i.e., downward) movement of the second connector 504, in order to restrict further rotation of the second connector 504. The latch lock 500 further includes a stop pin 520 coupled to the second connector 504. The stop pin 520, upon coming in contact with a bottom end 502b of the lever 502, restricts a further rotation of the lever 502 around the first pivoted joint 522 of the second connector 504. The operation of the latch lock 500 is described in conjunction with FIGS. 6A and 6B.

FIGS. 6A and 6B are schematic diagrams that collectively illustrate operations of the latch lock 500 of FIG. 5, in accordance with another exemplary embodiment of the disclosure.

With reference to FIG. 6A, the schematic diagram 600A illustrates the latch lock 500 being engaged with the base plate 116. Due to an upward movement of the top plate 120 relative to the track plate 122 (as shown in FIG. 2B), tension in the tension spring 508 is gradually released, causing the lever 502 to rotate around the first pivoted joint 522 of the second connector 504. As a result, the tip end 502a of the lever 502 protrudes outward of a corresponding guide slot to engage with the base plate 116 and the bottom end 502b of the lever 502 then comes in contact with the stop pin 520 (as shown in FIG. 5). It will be apparent to a person having ordinary skill in the art that the stop pin 520 of the latch lock 500 is similar to the stop pin 318 of the latch lock 202 and blocks any further movement of the lever 502.

With reference to FIG. 6B, the schematic diagram 600B illustrates the latch lock 500 of the robotic apparatus 108a being engaged with the base plate 116 while the MSU 106a is toppling. The toppling of the MSU 106a, when lifted by the robotic apparatus 108a, may be caused due to an uneven distribution of the weight of the inventory items stored in the MSU 106a or an uneven work floor. Due to the toppling of the MSU 106a, the base plate 116 that is engaged with the latch lock 500 exerts pressure on the lever 502. The lever 502, being in contact with the stop pin 520, does not rotate further and in turn exerts pressure on the second connector 504. Due to the pressure exerted by the lever 502, the second connector 504 moves towards the top plate 120. The second connector 504, due to the pressure exerted by the lever 502, rotates around a second pivoted joint 602 of the third connector 506 and moves away (i.e., an upward movement) from the track plate 122. The rotation of the second connector 504 is blocked when the blocking pin 518 (shown in FIG. 5) comes in contact with the top plate 120. The movement of the second connector 504 causes the first and second support springs 510 and 512 to get compressed by the top plate 120. The compression in the first and second support springs 510 and 512 delays the pressure or force, being exerted due to the toppling of the MSU 106a, from reaching the remaining components of the robotic apparatus 108a. The compression in the first and second support springs 510 and 512 distributes the pressure over the top plate 120. Such distribution of pressure prevents the robotic apparatus 108a from a sudden jerk that may cause a change in direction or path of the robotic apparatus 108a. Such a mechanism for handling pressure exerted on the robotic apparatus 108a allows the MSU 106a to settle on the top plate 120 without causing any damage to the robotic apparatus 108a.

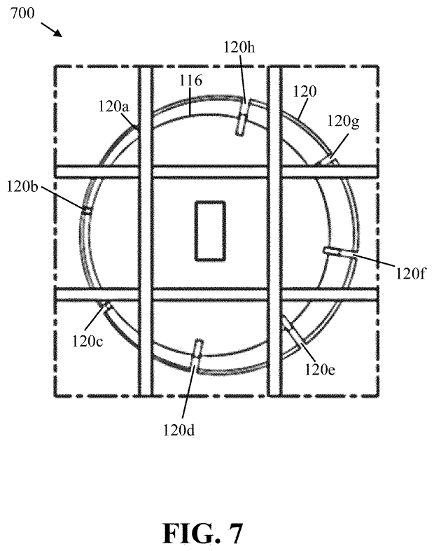

FIG. 7 is a schematic diagram 700 that illustrates an exemplary scenario of alignment between the base plate 116 of the MSU 106a and the top plate 120 of the robotic apparatus 108a, in accordance with an exemplary embodiment of the disclosure. In FIG. 7, a cross-section view of the MSU 106a being lifted by the robotic apparatus 108a is shown. As shown by FIG. 7, the base plate 116 is not centrally aligned with the top plate 120 of the robotic apparatus 108a. The base plate 116 has its center positioned towards a left of the center of the top plate 120. The misalignment between the top plate 120 and the base plate 116 may be caused due to a navigational error of the robotic apparatus 108a or uneven work floor 402 of the storage facility 102.

Due to the misalignment between the top plate 120 and the base plate 116, the guide slots 120a, 120b, and 120c are overlapped (or obstructed) by the base plate 116. As a result, the latch locks corresponding to the guide slots 120a, 120b, and 120c get blocked or hindered by the base plate 116, thus preventing the levers of these latch locks from protruding outward from the corresponding guide slots 120a, 120b, and 120c. Hence, the latch locks corresponding to the guide slots 120a, 120b, and 120c do not engage with the base plate 116. The latch locks corresponding to the guide slots 120d, 120e, 120f, 120g, and 120h are not blocked or hindered (or are unobstructed) by the base plate 116, thus the levers of these latch locks protrude outwards from the corresponding guide slots 120d, 120e, 120f, 120g, and 120h. The latch locks corresponding to the guide slots 120e and 120f are not completely engaged with the base plate 116 due to misalignment between the top plate 120 and the base plate 116. Thus, a count of latch locks of the robotic apparatus 108a that gets engaged with the base plate 116 depends upon the degree of alignment between the top plate 120 and the base plate 116, and the dimensions of the base plate 116. In other words, based on the degree of alignment between the top plate 120 and the base plate 116, and the dimensions of the base plate 116, one or more latch locks of the plurality of latch locks of the robotic apparatus 108a are engaged with the base plate 116 of the MSU 106a.

When the count of latch locks engaging with the base plate 116 is less than the permissible limit of the latch locks, the control server 110 may instruct the robotic apparatus 108a to lower the top plate 120, correct the alignment between the top plate 120 and the base plate 116, and re-attempt the lifting. In a scenario, where even after multiple attempts, a desired alignment is not achieved between the top plate 120 and the base plate 116, the control server 110 may instruct one of the remaining set of robotic apparatus 108 to lift the MSU 106a. Thus, the selection of the set of robotic apparatus 108 for lifting the MSUs 106 by the control server 110 is based on a conformity between the dimensions of an MSU base plate and a top plate of the set of robotic apparatus 108.

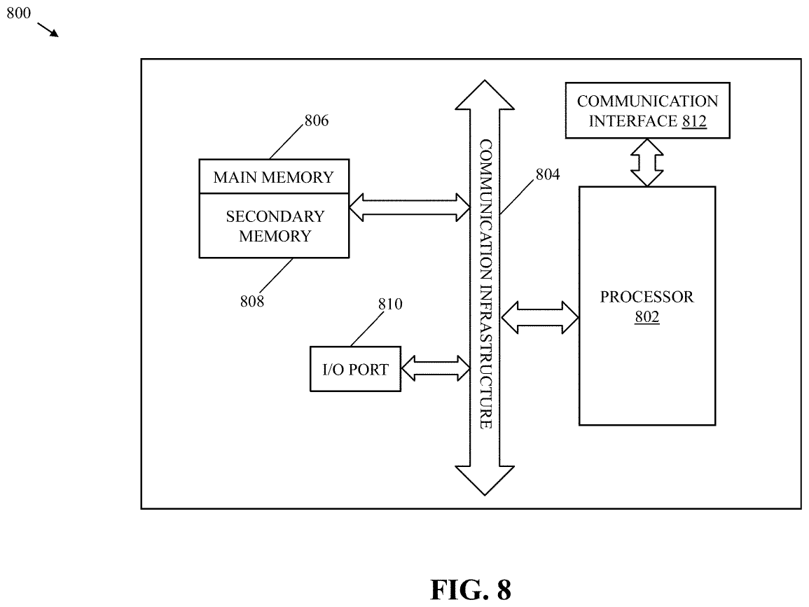

FIG. 8 is a block diagram that illustrates a system architecture of a computer system 800 for transportation of inventory items in the storage facility 102, in accordance with an exemplary embodiment of the disclosure. An embodiment of the disclosure, or portions thereof, may be implemented as computer-readable code on the computer system 800. In one example, the control server 110 of FIG. 1 may be implemented in the computer system 800 using hardware, software, firmware, non-transitory computer-readable media having instructions stored thereon, or a combination thereof and may be implemented in one or more computer systems or other processing systems. Hardware, software, or any combination thereof may embody modules and components used to implement the methods for transporting inventory in the storage facility 102.

The computer system 800 may include a processor 802 that may be a special purpose or a general-purpose processing device. The processor 802 may be a single processor or multiple processors. The processor 802 may have one or more processor “cores.” Further, the processor 802 may be coupled to a communication infrastructure 804, such as a bus, a bridge, a message queue, the communication network 112, a multi-core message-passing scheme, or the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording media.

The computer system 800 may further include an input/output (I/O) port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may be signals, such as electronic, electromagnetic, optical, or other signals as will be apparent to a person skilled in the art. The signals may travel via a communications channel, such as the communication network 112, which may be configured to transmit the signals to the various devices that are communicatively coupled to the computer system 800. Examples of the communication channel may include wired, wireless, and/or optical media such as cable, fiber optics, a phone line, a cellular phone link, a radio frequency link, and the like. The main memory 806 and the secondary memory 808 may refer to non-transitory computer-readable mediums that may provide data that enables the computer system 800 to implement the methods for transporting inventory in the storage facility 102.

The disclosed embodiments encompass numerous advantages. Exemplary advantages of the disclosed methods include, but are not limited to, securing the MSUs 106 to the set of robotic apparatus 108 during transportation. Engagement between the plurality of latch locks (e.g., the first and second latch locks 202 and 203) and the base plate 116 prevents the MSU 106a from toppling during transportation. Thus, the damage caused to inventory and operators in the storage facility 102, and downtime of the storage facility 102 due to toppling of the MSUs 106 are reduced. Since the MSUs 106 are prevented from toppling, there is no requirement to reserve space around an assembly of an MSU and a robotic apparatus, thereby, improving grid-space utilization in the storage facility 102. As the MSUs 106 are engaged with the set of robotic apparatus 108 during transportation, the control server 110 has the flexibility to have larger COG tolerance regions for the MSUs 106, which in turn improves space utilization of the MSUs 106. Due to technological improvements in the MSUs 106, the set of robotic apparatus 108, and the control server 110, the MSUs 106 are prevented from toppling without any manual intervention or requirement of expensive hardware and circuitry, such as electromagnetic sensors. Further, existing MSUs may require minor structural modifications, such as attachment of the base plates, for implementing the disclosed method, thereby making the system and method of the disclosure backward compatible.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for transporting inventory in a storage facility. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A system comprising:
a robotic apparatus comprising:
a track plate;
a top plate that is placed above the track plate, and spaced apart from the track plate, wherein the top plate is configured to move in a vertical direction between a resting position and one of a plurality of raised positions with respect to the track plate;
a latch lock mechanism positioned between the top plate and the track plate;
a lifting mechanism coupled with the top plate, and configured to control a movement of the top plate with respect to the track plate, wherein based on the control of the movement of the top plate, the latch lock mechanism is actuated; and
a control device configured to:
verify an alignment of the top plate with a base plate of a payload based on the robotic apparatus being stationed beneath the payload;
control the lifting mechanism to lift the top plate from the resting position to a first raised position at a first height at which the top plate comes in contact with the base plate, wherein based on the lifting of the top plate, the latch lock mechanism is actuated and securely engages with the base plate; and
control the lifting mechanism to lift the top plate from the first raised position to a second raised position at a second height based on the engagement of the latch lock mechanism with the base plate thereby lifting the payload off a work floor of a storage area.

2. The system of claim 1, wherein the control device is further configured to:
navigate the robotic apparatus from a first location to a second location for transporting the lifted payload; and
control the lifting mechanism to lower the top plate from the second raised position to the first raised position based on the transportation of the payload to the second location, and wherein based on the lowering of the top plate to the first raised position, the payload contacts the work floor of the storage area.

3. The system of claim 2, wherein the control device is further configured to instruct the lifting mechanism to lower the top plate from the first raised position to the resting position to disengage the latch lock mechanism from the base plate.

4. The system of claim 1, wherein the latch lock mechanism comprises a plurality of latch locks that actuate based on the movement of the top plate from the resting position to the first raised position, thereby causing the actuation of the latch lock mechanism.

5. The system of claim 4, wherein the control device is further configured to verify the alignment of the top plate with the base plate based on a count of latch locks of the plurality of latch locks whose movement is unobstructed by the base plate being greater than or equal to a permissible limit.

6. The system of claim 4, wherein a first latch lock of the plurality of latch locks comprises:
a connector;
a lever pivoted to the connector at a pivoted joint; and
a tension spring attached to the connector and the lever, wherein the connector is attached to a bottom of the top plate.

7. The system of claim 6, wherein the top plate comprises a plurality of guide slots such that a tip end of the lever remains inserted in a first guide slot of the plurality of guide slots and a bottom end of the lever remains in contact with the track plate based on the top plate being at the resting position.

8. The system of claim 7, wherein based on the movement of the top plate from the resting position to the first raised position, tension in the tension spring is released, thereby causing the lever to rotate around the pivoted joint such that the tip end of the lever protrudes outwards of the guide slot and away from the track plate to engage with the base plate.

9. The system of claim 8, wherein the first latch lock further comprises a stop pin coupled to the connector, and positioned such that the stop pin contacts the bottom end of the lever based on the rotation of the lever around the pivoted joint.

10. The system of claim 4, wherein the control device is further configured to determine a successful engagement of the latch lock mechanism with the base plate based on a count of latch locks of the plurality of latch locks that are engaged with the base plate being greater than or equal to a permissible limit.

11. The system of claim 4, wherein a first latch lock of the plurality of latch locks comprises:
a lever;
a first connector, wherein the lever is pivotally coupled to the first connector at a first pivoted joint;
a second connector that is pivotally coupled to the first connector at a second pivoted joint, and affixed to a bottom of the top plate; and
a tension spring that is coupled to the lever and the first connector.

12. The system of claim 11, wherein the first latch lock further comprises:
a first support spring and a second support spring, wherein the first connector is coupled to the first support spring and the second support spring, wherein the first support spring and the second support spring are positioned on either side of the lever, and wherein the first support spring and the second support spring remain in contact with the top plate.

13. The system of claim 12, wherein the first latch lock further comprises a blocking pin that protrudes from a surface of the first connector and contacts the top plate based on a downward movement of the first connector.

14. The system of claim 1, wherein the robotic apparatus further comprises a housing, and wherein the track plate is affixed to the top of the housing.

15. The system of claim 1, further comprising a control server configured to communicate a transit instruction to the robotic apparatus, and wherein the transit instruction includes reference marker details of the payload and path details of a path that is to be traversed by the robotic apparatus for transporting the payload from a first location to a second location.

16. The system of claim 15, wherein the control server is further configured to select the robotic apparatus for lifting the payload based on a conformity between dimensions of the base plate of the payload and the top plate of the robotic apparatus.

17. The system of claim 1, wherein the robotic apparatus further comprises a plurality of wheels, and wherein the control device may be configured to determine a position of a Center of Gravity (COG) of the payload based on weight exerted by the payload on the plurality of wheels of the robotic apparatus.

18. The system of claim 1, wherein the control device is further configured to verify the alignment of the top plate with the base plate based on an alignment of a center of the base plate with a center of the top plate.
